(19) United States
(12) Patent Application Publication
(10) Pub. No.: US 2019/0077388 A1
(43) Pub. Date: Mar. 14, 2019

(54) SOLENOID VALVE FOR BRAKE SYSTEM

(71) Applicant: MANDO CORPORATION, Pyeongtaek-si (KR)

(72) Inventor: Chung Jae LEE, Gunpo-si (KR)

(21) Appl. No.: 16/128,374

(22) Filed: Sep. 11, 2018

(30) Foreign Application Priority Data
Sep. 11, 2017 (KR) 10-2017-0115813
Sep. 11, 2017 (KR) 10-2017-0115820

(51) Int. Cl. B60T 13/68; B60T 17/04; F16K 31/06; F16K 51/00

(52) U.S. Cl. CPC B60T 13/686; B60T 17/04; F16K 31/0648; B60T 2270/306; F16K 51/00; B60T 2270/10; F16K 31/0668

(57) ABSTRACT

A solenoid valve for a brake system to control a flow rate of a flow path connecting a first port with a second port includes: an armature disposed inside a sleeve and configured to vertically move in an axial direction together with a plunger to open or close an orifice of a seat; an elastic member providing an elastic force to the armature; a magnetic core configured to accommodate the seat therein and provide a driving force in a direction opposite to the elastic member; an outer filter coupled to a lower side of the seat; an inlet filter coupled to a lower side of the outlet filter; and a lip seal interposed between the outlet filter and the inlet filter and including an inclined protrusion to allow a unidirectional flow of a fluid, wherein the solenoid valve has a flow path opened or closed by vertical movement of the armature and a unidirectional flow path via the lip seal.

### CROSS-REFERENCE TO RELATED APPLICATION(S)

This application claims the benefit of Korean Patent Application Nos. 2017-0115813, filed on Sep. 11, 2017 and 2017-0115820, filed on Sep. 11, 2017 in the Korean Intellectual Property Office, the disclosure of which is incorporated herein by reference.

### BACKGROUND

### 1. Field

Embodiments of the present disclosure relate to a solenoid valve for a brake system generating a braking force by using an electrical signal corresponding to a brake pedal position.

### 2. Description of the Related Art

A hydraulic brake system for braking is essentially installed in the vehicle. In recent years, various types of brake systems have been suggested to obtain a more powerful and stable braking force. Examples of the hydraulic brake system include an anti-lock brake system (ABS) that prevents slip of wheels during braking, a brake traction control system (BTCS) that inhibits slip of driving wheels during sudden unintended acceleration or rapid acceleration, and an electronic stability system (ESC) that stably maintains a running state of a vehicle by controlling a hydraulic pressure of a brake by combining the ABS and the BTCS.

Meanwhile, in the case of a vehicle attitude control system, a predetermined or higher level of flow rate is required to operate or release a brake. A plurality of electronically controlled solenoid valves is installed in a modulator block to realize such a brake system.

The aforementioned solenoid valve generally includes a hollow valve housing inserted into a bore of a modulator block and having an inlet and an outlet communicating with a modulator block, a hollow cylindrical sleeve inserted through an upper portion of the valve housing and coupled thereto by welding, a valve seat press-fitted into the valve housing and having an orifice, a magnetic core coupled to the sleeve at the opposite side to the valve housing by welding, and an armature movably installed in the sleeve.

### RELATED ART

### Patent Documents

(Patent Document 0001) Patent Registration No. 10-1276072, Jun. 18, 2013)

### SUMMARY

Therefore, it is an aspect of the present disclosure to provide a solenoid valve for a brake system having a check valve function.

Additional aspects of the disclosure will be set forth in part in the description which follows and, in part, will be obvious from the description, or may be learned by practice of the disclosure.

According to an aspect of an embodiment, a solenoid valve for a brake system to control a flow rate of a flow path connecting a first port with a second port includes: an armature disposed inside a sleeve and configured to vertically move in an axial direction together with a plunger to open or close an orifice of a seat; an elastic member providing an elastic force to the armature; a magnetic core configured to accommodate the seat therein and provide a driving force in a direction opposite to the elastic member; an outer filter coupled to a lower side of the seat; an inlet filter coupled to a lower side of the outlet filter; and a lip seal interposed between the outlet filter and the inlet filter and including an inclined protrusion to allow a unidirectional flow of a fluid, wherein the solenoid valve has a flow path opened or closed by vertical movement of the armature and a unidirectional flow path via the lip seal.

The outlet filter may include a first filter located at a surface facing the second port, a hollow hole to control a flow rate, a large diameter portion press-fitted into a lower side of the seal for airtightness with the modulator block at the opposite side to the seat, and an inner receiving portion to be assembled to the lip seal.

The inlet filter may include a second filter located at a surface facing the first port and an opening communicating with the outlet hollow hole, may be assembled to a lower side of the outlet filter, and may restrain movement of the lip seal when a pressure is applied thereto by restraining the lip seal together with the outer filter

The inlet filter may further include a support protruding downward to maintain a gap with the modulator block and secure a flow path.

The lip seal may be accommodated in the outlet filter, the inclined protrusion is provided at an outer side of the lip seal, and the unidirectional flow path may pass through an outlet flow path hole formed in the outlet filter, the inclined protrusion, and an inlet flow path hole of the inlet filter.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a portion of a conventional electronic brake system;

FIG. 2 is a view of a solenoid valve for a brake system according to an embodiment of the present disclosure;

FIG. 3 is a cross-sectional view of an outlet filter taken along line X-X of FIG. 2;

FIG. 4A is a cross-sectional view of an outlet filter according to the embodiment taken along line Y-Y;

FIG. 4B is a bottom view of the outlet filter;

FIG. 5 is a view of a solenoid valve for a brake system according to another embodiment of the present disclosure;

FIG. 6A is a plan view of an orifice unit according to the embodiment of FIG. 5;

FIG. 6B is a cross-sectional view taken along line X-X of FIG. 6A; and

FIG. 6C is a bottom view of the orifice unit.

### DETAILED DESCRIPTION

Reference will now be made in detail to the embodiments of the present disclosure, examples of which are illustrated in the accompanying drawings, wherein like reference numerals refer to like elements throughout. The present disclosure may, however, be embodied in many different forms and should not be construed as being limited to the embodiments set forth herein; rather, these embodiments are provided so that this disclosure will be thorough and complete, and will fully convey the concept of the disclosure to those of ordinary skill in the art. The drawings may be exaggerated, omitted, or schematically illustrated for convenience of description and clarity.

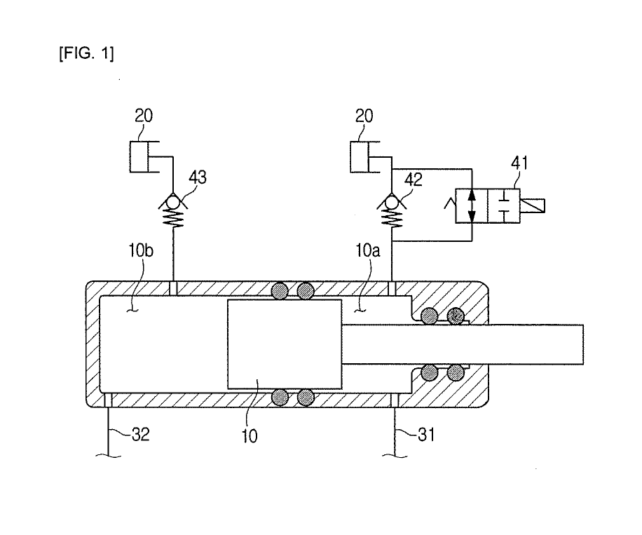

FIG. 1 is a view illustrating a portion of a conventional electronic brake system. Referring to FIG. 1, a conventional electronic brake system includes a pump piston 10 electronically actuated in response to a pedaling force of a driver, a reservoir 20 to store a working fluid, first and second pump chambers 10a and 10b having a volume varying by the pump piston 10, a first hydraulic line 31 connecting the first pump chamber 10a with one pair of wheels, a second hydraulic line 32 connecting the second pump chamber 10b with the other pair of wheels, a solenoid value 41 and a first check valve 42 installed in parallel at a line connecting the first pump chamber 10a with the reservoir 20, and a second check valve 43 installed at a line connecting the second pump chamber 10b with the reservoir 20.

In such electronic brake systems, when the driver presses the brake pedal, an electronic control unit (ECU) calculates a required pressure upon receiving a travel sensor signal and generates the pressure by operating the pump piston 10 by driving a motor.

Meanwhile, in integrated brake systems (IDBs), a pump piston 10 installed to move in a reciprocating manner is used and a first check valve 42 for sucking a working fluid from a reservoir 20 during forward pressing and a solenoid valve for maintaining a pressure during backward pressing are applied thereto.

The first check valve 42 is separately provided to smoothly supply the working fluid into the first pump chamber 10a when a required pressure is generated by operating the pump piston 10 by driving a motor. Since components of each of the solenoid valve 41 and the first check valve 42 need to be installed in parallel, the configuration becomes complicated and manufacturing costs increase.

Also, since another flow path needs to be added to use the first check valve 42, circuit designing of a brake system becomes complicated and a block size also increases. Thus, by using a solenoid valve for a brake system having a check valve function which will be described later, an unnecessary hydraulic circuit in which the check valve and the solenoid valve are installed in parallel may be omitted.

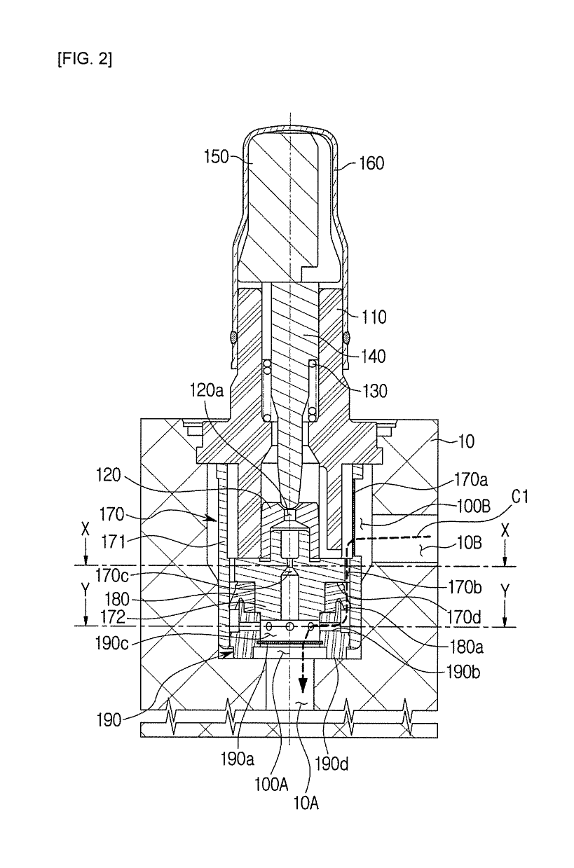

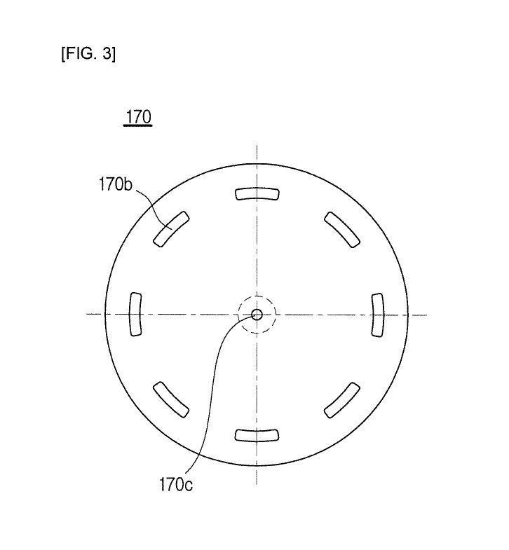

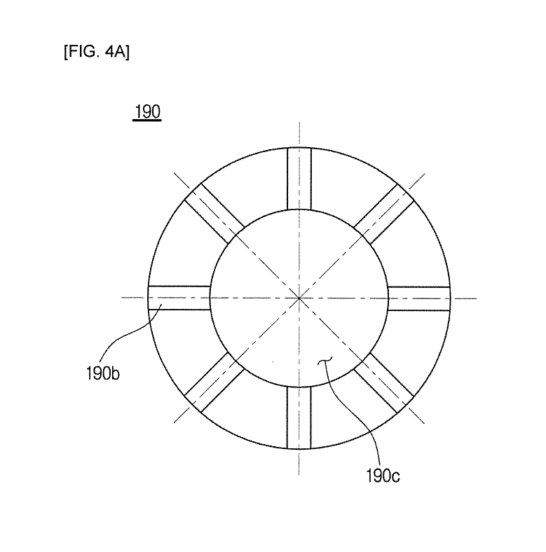

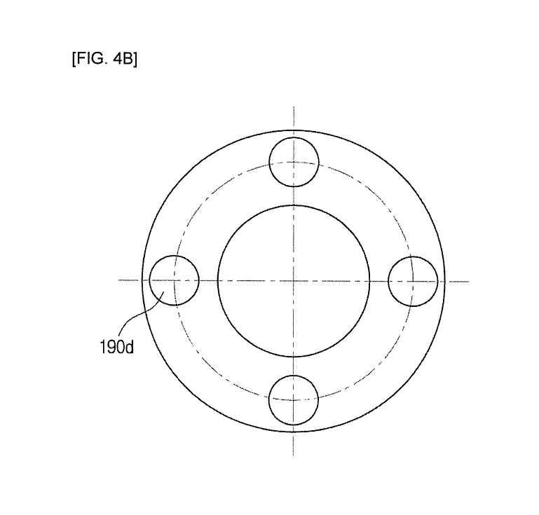

FIG. 2 is a view of a solenoid valve for a brake system according to an embodiment of the present disclosure. FIG. 3 is a cross-sectional view of an outlet filter taken along line X-X of FIG. 2. FIG. 4A is a cross-sectional view of an outlet filter according to the embodiment taken along line Y-Y. FIG. 4B is a bottom view of the outlet filter. Hereinafter, the present disclosure will be described with reference to the drawings.

A solenoid valve 100 according to an embodiment may be press-fitted into a bore of a modulator block 10. In addition, the solenoid valve 100 includes an armature 150 disposed in a sleeve 160 and configured to vertically move along an axial direction together with a plunger 140 to open or close an orifice 120a of a seat 120, an elastic member 130 to provide an elastic force to the armature 150, a magnetic core 110 configured to accommodate the seat 120 and provide a driving force to the armature 150 in a direction opposite to the elastic member 130, an outlet filter 170 coupled to a lower side of the seat 120, an inlet filter 190 coupled to a lower side of the outlet filter 170, and a lip seal 180 interposed between the outlet filter 170 and the inlet filter 190 and including an inclined protrusion 180a allowing only a unidirectional flow of a fluid.

The solenoid valve 100 includes a first opening 100A provided in a surface facing a first port 10A and a second opening 100B provided at a surface facing a second port 10B. In this case, the solenoid valve 100 controls a flow rate of a flow path from the first port 10A sequentially to the first opening 100A, the second opening 100B, and the second port 10B by opening or closing the flow path using the armature 150 that vertically moves by the magnet core 110.

The magnet core 110 is coupled to a lower side of the sleeve 160 in a press-fitted or welded form to close an open lower portion of the sleeve 160. Although not shown herein, for more tight coupling between the magnetic core 110 and the sleeve 160, the magnet core 110 may have a coupling groove (not shown) and the magnetic core 110 and the sleeve 160 may be assembled by pressing the sleeve 160 to be caught by the coupling groove (not shown). This coupling structure may facilitate coupling of the sleeve 160 to the magnetic core 110 and simplify a coupling process in comparison with conventional welding methods.

The sleeve 160 is press-fitted or welded to the magnet core 110, accommodates the armature 150 therein, and guides the armature 150 to move only in a longitudinal direction by restraining movement of the armature 150 in a width direction.

The seat 120 may be accommodated and press-fitted into a hollow hole formed in the magnet core 110. The seat 120 may be provided with the orifice 120a and the plunger 140, which will be described later, may open or close the orifice 120a, thereby controlling a flow rate of a fluid passing through the flow path.

The armature 150 may be installed in the sleeve 160 to be vertically movable and may have a shape corresponding to a shape of the sleeve 160 having a diameter increasing downward from an upper side to a lower side. Also, the plunger 140 in contact with the seat 120 is provided at a lower end thereof.

The plunger 140 may extend toward the seat 120 from the lower side of the armature 150 and may have a stepped portion to receive an elastic force from the elastic member 130 supported by the magnet core 110.

The outlet filter 170 may include a first filter 170a located at a surface facing the second port 10B, an outlet hollow hole 170c to control the flow rate, a large diameter portion 171 press-fitted into the lower side of the seat 120 and having a size corresponding to that of the bore of the modulator block 10 for airtightness with the modulator block 10 at the opposite side of the seat 120, and an inner receiving portion 170d to be assembled to the lip seal 180. An outlet flow path hole 170b may be formed in the outlet filter 170 for the flow of a fluid in a unidirectional flow path C1.

The lip seal 180 may include the inclined protrusion 180a coupled to an outer peripheral surface of a small diameter portion 172 of the outlet filter 170, deformed by a pressure difference, and protruding outward with an inclined portion to allow only the unidirectional flow of the fluid. When a pressure of the second port 10B is greater than that of the first port 10A, the inclined protrusion 180a is bent in a narrowing direction to form the unidirectional flow path C1. On the contrary, when the pressure of the second port 10B is less than that of the first port 10A, the inclined protrusion 180a is bent in a widening direction, the unidirectional flow path C1 is not formed.

The lip seal 180 is coupled to the inside of the outlet filter 170 such that the inclined protrusion 180a is provided at an outer side of the lip seal 180 and the unidirectional flow path C1 is provided to pass through the outlet flow path hole 170b formed in the outlet filter 170, the inclined protrusion 180a, and an inlet flow path hole 190b of the inlet filter 190.

The inlet filter 190 may include a second filter 190a located at a surface facing the first port 10A to prevent introduction of foreign matter and an inlet hollow hole 190c communicating with the outlet hollow hole 170c, may be coupled to a lower side of the outlet filter 170, and may restrain movement of the lip seal 180 when a pressure is applied by restraining the lip seal 180 together with the outlet filter 170. Also, the inlet filter 190 may include a support 190d protruding downward to maintain a gap with the modulator block 10 and secure a flow path.

The solenoid valve 100 according to an embodiment of the present disclosure may have two flow paths, i.e., an orifice flow path that is opened or closed by vertical movement of the armature 150 and a unidirectional flow path C1 via the lip seal 180.

The orifice flow path may normally be open and may be closed when a valve operates. When electric power is applied to the magnet core 110, a magnetic force is generated to move the armature 150 downward. Then, the armature 150 compresses the elastic member 130 so that the plunger 140 moves to be in contact with the orifice 120a. Thus, the flow of the fluid passing through the orifice 120a, the outlet hollow hole 170c of the outlet filter 170, and the inlet hollow hole 190c of the inlet filter 190 is blocked.

The unidirectional flow path C1 is a one-way path of the working fluid from the second port 10B to the first port 10A sequentially via the outlet flow path hole 170b, the inclined protrusion 180a of the lip seal 180, and the inlet flow path hole 190b of the inlet filter 190. The unidirectional flow path C1 is opened as the inclined protrusion 180a is bent inward when the pressure of the second port 10B is relatively greater than that of the first port 10A. Thus, the function of the check valve is replaced by the lip seal 180.

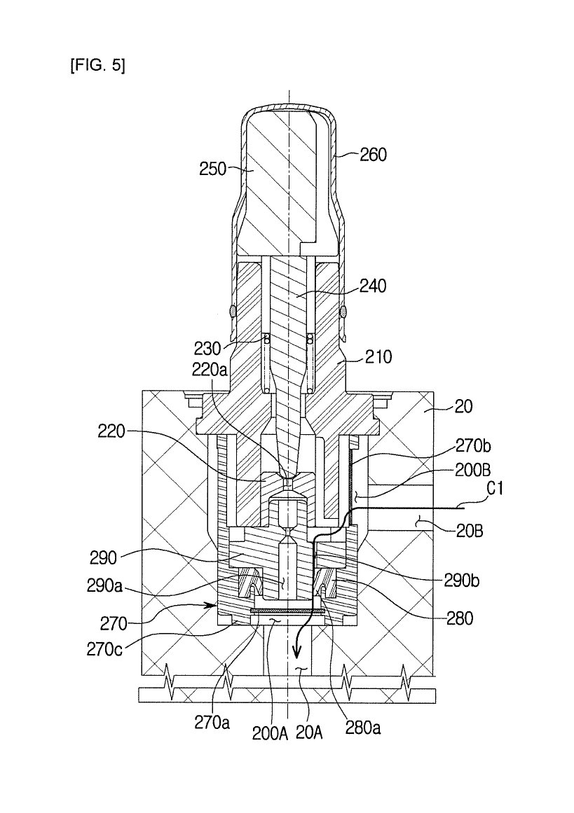

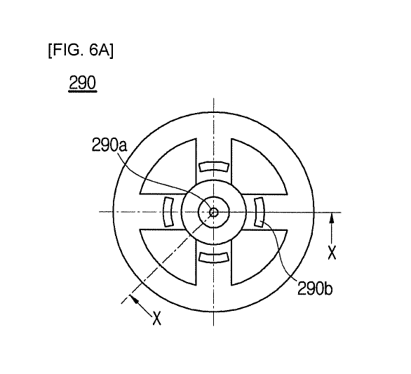

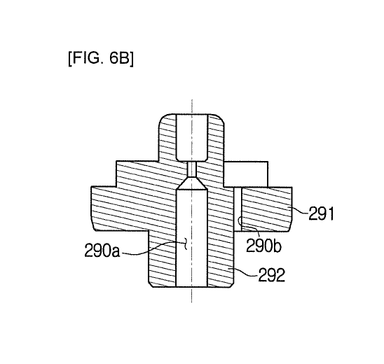

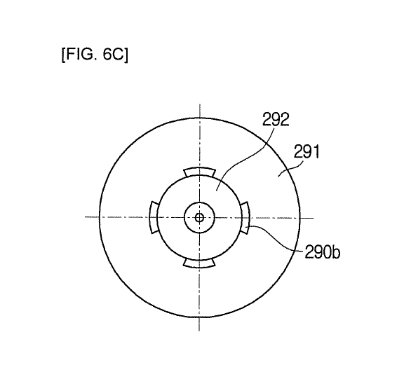

FIG. 5 is a view of a solenoid valve for a brake system according to another embodiment of the present disclosure. FIG. 6A is a plan view of an orifice unit according to the embodiment of FIG. 5. FIG. 6B is a cross-sectional view taken along line X-X of FIG. 6A. FIG. 6C is a bottom view of the orifice unit.

A solenoid valve 200 according to another embodiment of the present disclosure is press-fitted into a bore of a modulator block 20. In addition, the solenoid valve 200 includes an armature 250 disposed in a sleeve 260 and configured to vertically move along an axial direction together with a plunger 240 to open or close an orifice 220a of a seat 220, an elastic member 230 to provide an elastic force to the armature 250, a magnet core 210 configured to accommodate the seat 220 and provide a driving force to the armature 250 in a direction opposite to the elastic member 230, an orifice unit 290 coupled to a lower side of the seat 220, a filter member 270 coupled to a lower side of the orifice unit 290, and a lip seal 280 interposed between the orifice unit 290 and the filter member 270 and including an inclined protrusion 280a allowing only a unidirectional flow of a fluid.

The solenoid valve 200 includes a first opening 200A provided at a surface facing a first port 20A and a second opening 200B provided at a surface facing a second port 20B. In this case, the solenoid valve 200 may control a flow rate of a flow path from the first port 20A sequentially to the first opening 200A, the second opening 200B, and the second port 20B by opening or closing the flow path using the armature 250 that vertically moves by the magnet core 210.

The magnet core 210 is coupled to a lower side of the sleeve 260 in a press-fitted or welded form to close an open lower portion of the sleeve 260. Although not shown herein, for more tight coupling between the magnet core 210 and the sleeve 260, the magnet core 210 may have a coupling groove and the sleeve 260 may be assembled to the magnet core 210 by pressing the sleeve 260 to be caught by the coupling groove. This coupling structure may facilitate coupling of the sleeve 260 to the magnet core 210 and simplify a coupling process in comparison with conventional welding methods.

The sleeve 260 is press-fitted or welded to the magnet core 210, accommodates the armature 250 therein, and guides the armature 250 to move only in a longitudinal direction by restraining movement of the armature 250 in a width direction.

The seat 220 is press-fitted into a hollow hole formed in the magnet core 210. The seat 220 may be provided with the orifice 220a, and the plunder 240, which will be described later, may open or close the orifice 220a, thereby controlling a flow rate of a fluid passing through the flow path.

The armature 250 may be installed in the sleeve 260 to be vertically movable and may have a shape corresponding to a shape of the sleeve 260 having a diameter increasing downward from an upper side to a lower side. Also, the plunger 240 in contact with the seat 220 is provided at a lower end thereof.

The plunger 240 may extend toward the seat 220 from the lower side of the armature 250 and may have a stepped portion to receive an elastic force from the elastic member 230 supported by the magnetic core 210.

Referring to FIGS. 5, 6A, 6B, and 6C, the orifice unit 290 has a hollow hole 290a to control a flow rate, is press-fitted into the lower side of the seat 220, and includes an inner stepped portion formed of a large diameter portion 291 having a size corresponding to that of an inner diameter of the filter member 270 and a small diameter portion 292 to be assembled to the lip seal 280 which are disposed at the opposite side of the seat 220. A flow path hole 290b is formed in the orifice unit 290 for the flow of a fluid in a unidirectional flow path C1.

The lip seal 280 is installed between an inner surface of the filter member 270 and an outer surface of the orifice unit 290, the inclined protrusion 280a is provided at an inner portion of the lip seal 280, and the unidirectional flow path C1 is provided to pass through the flow path hole 290b of the orifice unit 290 and the inclined protrusion 280b.

The lip seal 280 is accommodated in the filter member 270 such that the inclined protrusion 280a is in contact with the outer peripheral surface of the small diameter portion 292 of the orifice unit 290 and includes the inclined protrusion 280a deformed by a pressure difference and protruding inward with an inclined portion to allow only the unidirectional flow of the fluid. When a pressure of the second port 20B is greater than that of the first port 20A, the inclined protrusion 280a is bent in a narrowing direction to form the unidirectional flow path C1. On the contrary, when the pressure of the second port 20B is less than that of the first port 20A, the inclined protrusion is bent in a widening direction, and thus the unidirectional flow path C is not formed.

The filter member 270 includes a first filter 270a disposed at a surface facing the first port 20A to prevent introduction of foreign matter, a second filter 270b disposed at a surface facing the second port 20B to prevent introduction of foreign matter, and a support 270c protruding from a lower portion to maintain a gap with the modulator block 20 and secure a flow path. The filter member 270 may be assembled to the lower side of the orifice unit 290 and may restrain the lip seal 280 together with the orifice unit 290 to restrain movement of the lip seal 280 when a pressure is applied thereto.

The solenoid valve 200 according to another embodiment of the present disclosure may have two flow paths, i.e., an orifice flow path that is opened or closed by vertical movement of the armature 250 and a unidirectional flow path C1 via the lip seal 280.

The orifice flow path may normally be open and may be closed when a valve operates. When electric power is applied to the magnet core 210, a magnetic force is generated to move the armature 250 downward. Then, the armature 250 compresses the elastic member 230 so that the plunger 240 moves to be in contact with the orifice 220a. Thus, the flow of the fluid passing through the orifice 220a and the hallow hole 290c of the orifice unit 290 is blocked.

The unidirectional flow path C1 is a one-way path of the working fluid from the second port 20B to the first port 20A sequentially via the flow path hole 290b, and the inclined protrusion 280a of the lip seal 280. In this case, the inclined protrusion 280a is bent inward when the pressure of the second port 20B is relatively greater than that of the first port 20A, thereby functioning as a check valve.

As is apparent from the above description, the solenoid valve having the check valve function by using the lip seal according to the present disclosure may simplify designing of a hydraulic circuit, thereby reducing manufacturing costs and improving mounting performance.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A solenoid valve for a brake system to control a flow rate of a flow path connecting a first port with a second port, the solenoid valve comprising:
an armature disposed inside a sleeve and configured to vertically move in an axial direction together with a plunger to open or close an orifice of a seat;
an elastic member providing an elastic force to the armature;
a magnetic core configured to accommodate the seat therein and provide a driving force in a direction opposite to the elastic member;
an outer filter coupled to a lower side of the seat;
an inlet filter coupled to a lower side of the outlet filter; and
a lip seal interposed between the outlet filter and the inlet filter and comprising an inclined protrusion to allow a unidirectional flow of a fluid,
wherein the solenoid valve has a flow path opened or closed by vertical movement of the armature and a unidirectional flow path via the lip seal.

2. The solenoid valve according to claim 1, wherein the outlet filter comprises:
a first filter located at a surface facing the second port;
an outlet hollow hole to control a flow rate;
an outlet flow path hole provided to be spaced apart from the outlet hollow hole in parallel;
a large diameter portion for airtightness with a modulator block; and
a small diameter portion having an outer surface to which the lip seal is assembled.

3. The solenoid valve according to claim 2, wherein the inlet filter comprises a second filter located at a surface facing the first port and an inlet hollow hole communicating with the outlet hollow hole, is assembled to a lower side of the outlet filter, and restrains movement of the lip seal when a pressure is applied thereto by restraining the lip seal together with the outer filter.

4. The solenoid valve according to claim 3, wherein the inlet filter further comprises an inlet flow path hole formed radially outward from the inlet hollow hole and a support protruding downward to maintain a gap with the modulator block.

5. The solenoid valve according to claim 4, wherein the inclined protrusion is provided at an outer portion of the lip seal, and
the unidirectional flow path passes through the outlet flow path hole, the inclined protrusion, and the inlet flow path hole.

6. A solenoid valve for a brake system to control a flow rate of a flow path connecting a first port with a second port, the solenoid valve comprising:
an armature disposed inside a sleeve and configured to vertically move in an axial direction together with a plunger to open or close an orifice of a seat;
an elastic member providing an elastic force to the armature;
a magnetic core configured to accommodate the seat therein and provide a driving force to the armature in a direction opposite to the elastic member;
an orifice unit coupled to a lower side of the seat and having a hollow hole communicating with the orifice of the seat;
a filter member to prevent introduction of foreign matter; and
a lip seal interposed between the orifice unit and the filter member and comprising an inclined protrusion to allow a unidirectional flow path of a fluid,
wherein the solenoid valve has an orifice flow path opened or closed by vertical movement of the armature and a unidirectional flow path via the lip seal.

7. The solenoid valve according to claim 6, wherein the orifice unit comprises a large diameter portion to be coupled to the filter member, a small diameter portion in contact with the lip seal, and a flow path hole forming the unidirectional flow path to be spaced apart from a side of the hollow hole, and restrains the lip seal together with the filter member, thereby restraining movement of the lip seal when a pressure is applied thereto.

8. The solenoid valve according to claim 7, wherein the filter member comprises a first filter located at a surface facing the first port and a second filter located at a surface facing the second port to prevent introduction of foreign matter.

9. The solenoid valve according to claim 8, wherein the filter member further comprises a support protruding from a lower portion to maintain a gap with the modulator block and secure a flow path.

10. The solenoid valve according to claim 9, wherein the lip seal is installed at an inner portion of the filter member and comprises the inclined protrusion to be located at an inner portion of the lip seal, and
the unidirectional flow path passes through the second filter, the flow path hole, the inclined protrusion, and the first filter.
